(19) United States
(12) Patent Application Publication
(10) Pub. No.: US 2021/0136119 A1
(43) Pub. Date: May 6, 2021

(54) COMPARING NETWORK SECURITY SPECIFICATIONS ACROSS EQUIVALENT NETWORKS

(71) Applicant: salesforce.com, inc., San Francisco, CA (US)

(72) Inventor: Toan Nguyen, Toa Payoh (SG)

(21) Appl. No.: 16/675,678

(22) Filed: Nov. 6, 2019

(51) Int. Cl. H04L 29/06; H04L 12/24

(52) U.S. Cl. CPC H04L 63/20; H04L 63/1433; H04L 41/12; H04L 41/0246; H04L 41/044

(57) ABSTRACT

A system receives network security specifications for two different networks that are equivalent. The system compares the two network security specifications expected to implement the same network security policy for the two equivalent networks and identifies possible discrepancies between them. The system generates a representation of relations between subnetworks of the corresponding network for each network security specification. The representation efficiently stores permitted connections between subnetworks. The system compares the representations corresponding to the two network security specifications to identify discrepancies across the two network security specifications. If discrepancies are identified across the two network security specifications the system generates a report identifying the discrepancies.

### BACKGROUND

### Field of Art

This disclosure relates in general to security in computer networks, and in particular to identifying discrepancies between network security specifications specified for two equivalent networks.

### Description of the Related Art

Enterprises typically use a network of computers to support their information technology needs. These computers often run services used by the enterprise, for example, databases, web servers, application servers, printer servers, logging services, and so on. Enterprises typically enforce a network security policy that specifies whether two services or two computers are permitted to interact with each other. The network security policy prevents malicious use of resources as well as accidental misuse of resources. A network security policy is specified using a network security specification that may be specified using a network security language.

An enterprise may maintain a network in a data center. Managing a data center can be a significant overhead since the enterprise needs to maintain the networking hardware and software as well as physical space and personnel for maintaining the network. As a result, there is a trend among enterprises to migrate from a data center based network architecture to a cloud based architecture. The cloud based network architecture allows the enterprise to outsource the maintenance of the network to a cloud service provider, for example AWS (AMAZON web services) or MICROSOFT AZURE.

When an enterprise migrates from an old network to a new network, the enterprise may want to implement the same network policy for the two networks. However, migrating from one network to a new network requires rewriting the network security policy using a new network security specification. This may be required if the new network does not support the network security language used by the network security specification of the old network. Furthermore, the IP addresses of the two networks are different since they are two distinct networks, thereby requiring a new network security specification.

The enterprise would like to know whether the two network security specifications actually implement the same network policy for the two networks. If the two network security specifications do not implement the same network policy, the enterprise would like to identify the discrepancies, so appropriate action may be taken. Conventional techniques determine discrepancies within the same network security specification for a network, for example, whether the specification includes one rule that permits a connection between two services and another rule that disallows connection between the same two services. However conventional techniques do not determine discrepancies between two distinct network security specifications that are expected to implement the same underlying network security policy for two equivalent networks.

### BRIEF DESCRIPTION OF DRAWINGS

FIG. 1 is a block diagram of a system environment for identifying discrepancies between network security specifications for two equivalent networks according to one embodiment.

FIG. 2 is a block diagram illustrating components of a system for identifying discrepancies between network security specifications for two equivalent networks according to one embodiment.

FIG. 3A illustrate a permitted connections structure according to an embodiment.

FIG. 3B illustrate a permitted connections structure according to another embodiment.

FIG. 3C illustrates a subnetwork mapping table that relates the subnetworks of two permitted connections structures according to an embodiment

FIG. 4 is a flow chart illustrating the process for identifying discrepancies between network security specifications for two equivalent networks according to one embodiment.

FIG. 5 is a flow chart illustrating the process for comparing permitted connections structures according to one embodiment.

FIG. 6 is a block diagram illustrating a functional view of a typical computer system for use in the environment of FIG. 1 according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “104A,” indicates that the text refers specifically to the element having that particular reference numeral. A reference numeral in the text without a following letter, such as “104,” refers to any or all of the elements in the figures bearing that reference numeral.

### DETAILED DESCRIPTION

An enterprise may implement two equivalent networks, for example, when migrating from one network architecture to another. The enterprise may implement the same network security policy for the two networks. Since the IP addresses of the two networks are different and the two networks may use different network security languages, the enterprise may use distinct network security specifications for each of the networks. Each network security specification is expected to implement the same network security policy for the corresponding network. Embodiments compare the two network security specifications to determine whether they represent the same network security policy and identify possible discrepancies between them.

The network security specification for a network defines services available in the network and defines permitted connections between the services. Since the two networks are equivalent, the network security specifications have matching services. Accordingly, both network security specifications identify the same service and associate the service with a corresponding subnetwork. For example, the subnetwork may represent the IP addresses of the computing systems implementing the service.

The system builds a mapping between subnetworks of the two networks that are associated with a matching service in the two networks. The system identifies corresponding services between the two network security specifications and stores a relation between the subnetworks associated with the service in the two networks. In an embodiment, the system stores a subnetwork mapping table for storing relations between corresponding subnetworks of the two networks.

The system uses the subnetwork mapping table to compare the two network security specifications for identifying any discrepancies between them. For each network security specification, the system generates a representation that relates subnetworks that are permitted to establish a connection according to that network security specification. The representation stores the network security information in a structure that allows efficient comparison of the underlying network security policies across network security specifications. The representation is also referred to as a permitted connections structure.

The permitted connections structure identifies for a given subnetwork, all other subnetworks that are permitted to connect with that subnetwork according to that network security specification. The system compares the permitted connections structures of the two network security specifications by matching corresponding pairs of subnetworks that are permitted to connect. The system identifies corresponding pairs of subnetwork based on the subnetwork mapping table. The system identifies discrepancies based on the comparison. A discrepancy indicates a pair of subnetworks that is permitted to connect in one representation but not permitted to connect in the other representation

If the system identifies discrepancies across the two network security specifications, the system takes appropriate actions, for example, generating a report or sending an alert.

### Overall System Environment

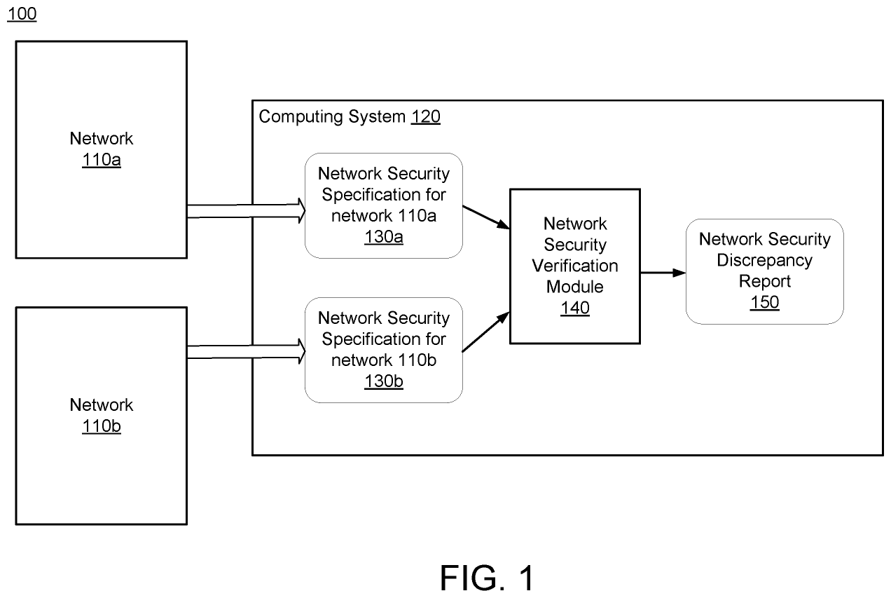

FIG. 1 is a block diagram of a system environment 100 for identifying discrepancies between network security specifications for two equivalent networks, according to one embodiment. FIG. 1 illustrates networks 110a and 110b and a computing system 120 that receives two network security specifications 130a and 130b for the networks 110a and 110b respectively and identifies discrepancies between the network security specifications. The system environment 100 may represent the information technology (IT) infrastructure of an enterprise.

Each of the networks 110a and 110b comprises computing systems and networking hardware that allows the computing systems to interact with each other. A computing system may be a server, a desktop computer, laptop, smart phone, tablet computer, or personal digital assistant (PDA). A computing system may provide one or more services, for example, databases, web servers, application servers, printer servers, logging services, and so on. A network may have multiple instances of each services. For example, there may be several databases, each possibly installed on a different computing system. Services often interact with each other, for example, a web server may interact with a database, an application server may interact with a logging server, and so on.

The networking hardware provides communication pathways between various computing systems. The networking hardware includes routers, switches, and so on as well as wired links such as cable or optics or wireless links such as Wi-Fi based on radio technology. The network uses a networking protocol such as the transmission control protocol/Internet protocol (TCP/IP), the User Datagram Protocol (UDP), the hypertext transport protocol (HTTP), etc. The data exchanged over the network 110 can be represented using technologies and/or formats including the hypertext markup language (HTML), the extensible markup language (XML), etc.

The networks 110a and 110b may have different network architectures. For example, one of the networks 110 may be a data center based network architecture and the other network 110 may be a cloud based network architecture. In a data center based network architecture, an enterprise maintains a data center and the corresponding hardware and software needed to implement the network. In a cloud based network architecture, the enterprise uses hardware and software services provided by a cloud service provider.

The computing system 120 is configured to receive network security specifications 130a and 130b that implement network policies for the networks 110a and 110b respectively and process them to identify discrepancies between the network security specifications. The computing system 120 includes a network security comparison module 140 that receives network security specifications 130a and 130b as input and processes them. The network security comparison module 140 generates a network security discrepancy report 150 that identifies any discrepancies between the network security specifications 130a and 130b.

The network security specification conforms to the syntax of a network security language. There may be multiple network security languages supported by the computing system 120. Furthermore, there may be different versions of the same network security language that have variations in syntax or semantics. For example, a version of network security language may implement certain default rules that may be different from other versions. A default rule may permit connections between services based on certain predefined criteria. For example, the network security language may support grouping of services such that all services assigned to the same group may be permitted to connect to each other. Embodiments of the invention identify discrepancies between permitted connections across subnetworks of a network caused by changes in default rules, even if the network security specification itself is not changed.

Following is an example snippet of a network security specification specified using a network security language that allows users to specify services and permitted connections between services.

network_security_Rule Rule1 {
consumer:

″type″: ″label″
″value″: ″webServer″

provider:

″type″: ″ipList″
″value″: ″database″

connection:

“protocol”: ″tcp″
“port”: “80”

}

The example network security specification shown above specifies a network security rule Rule1 that specifies fields including (1) a consumer, (2) a provider, and (3) a connection between the consumer and provider. Each of the consumer and provider fields have a type and a value attributes. The type field can be a label that specifies a service name or an internet protocol (IP) list representing a list of IP addresses or an IP range. If the type field is a label that specifies a service name, the specification further includes information identifying the subnetwork, for example, an IP list corresponding to the service name. The connection field specifies a protocol that can be used by the consumer to connect with the provider and a port number on which the consumer can connect with the provider. The rule may specify one or more connection fields allowing the consumer to connect with the provider using different networking protocols and/or networking ports.

Following is another example of a network security specification using a different network security language that allows users to specify service groups and permitted connections between service groups.

network_security_Rule Rule2 {
source_service_group: service1 service2 service3
destination_service_group: service4 service5
connection:

protocol: tcp port: 80
protocol: UDP port: 443

}

The example network security specification shown above specifies a network security rule Rule2 that specifies fields including (1) a source service group, (2) a destination service group, and (3) one or more connections between the source service group and the destination service group. Each of the source service group and destination service group fields specify a list of services. Although not shown in this example, the specification may further include information identifying a subnetwork, for example, an IP list corresponding to each service. The connection field specifies one or more protocols and corresponding port numbers that can be used by any service in the source service group to connect with a service in the destination service group.

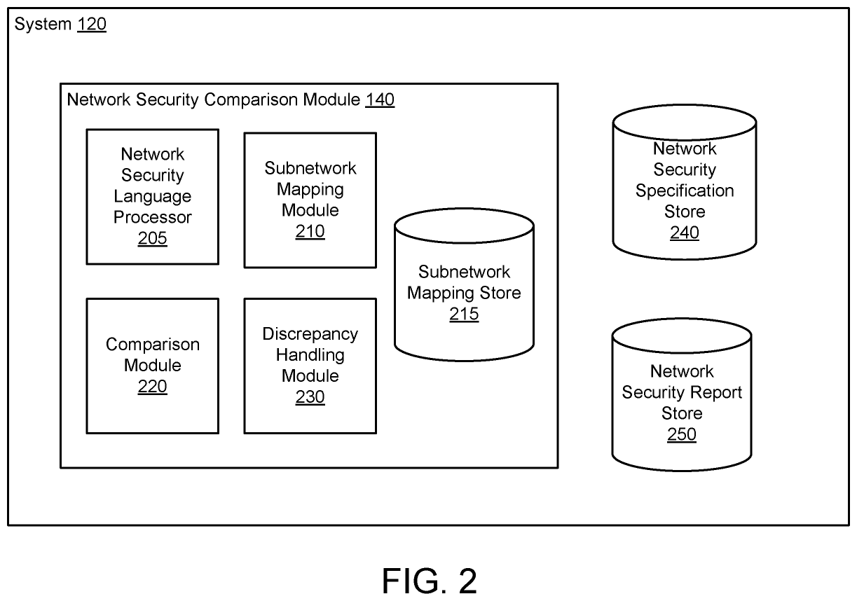

The network security comparison module 140 generates a network security discrepancy report 150 that identifies discrepancies between the network security specifications 130a and 130b. The computing system 120 may present the network security discrepancy report 150 to a user such as a system administrator via a user interface. Alternatively, the computing system 120 may send an alert to the user identifying the discrepancies between the network security specifications 130a and 130b. Details of the computing system 120 are further described herein, for example, in FIG. 2.

### System Architecture

FIG. 2 is a block diagram illustrating components of a system for identifying discrepancies between network security specifications for two equivalent networks, according to one embodiment. The computing system 120 comprises a network security comparison module 140, a network security specification store 240, and a network security report store 250. Other embodiments can have different and/or other components than the ones described here, and that the functionalities can be distributed among the components in a different manner.

The network security specification store 240 stores network security specifications 130. The network security specifications may be provided by a user, for example via a user interface displayed on a client device.

The network security comparison module 140 comprises modules including a network security language processor 205, subnetwork mapping module 210, a subnetwork mapping store 215, a comparison module 220, and a discrepancy handling module 230. Other embodiments may include more of fewer modules.

The network security language processor 205 parses an input network security specification according to the syntax of a network security language. The network security language processor 205 may include support for multiple network security languages.

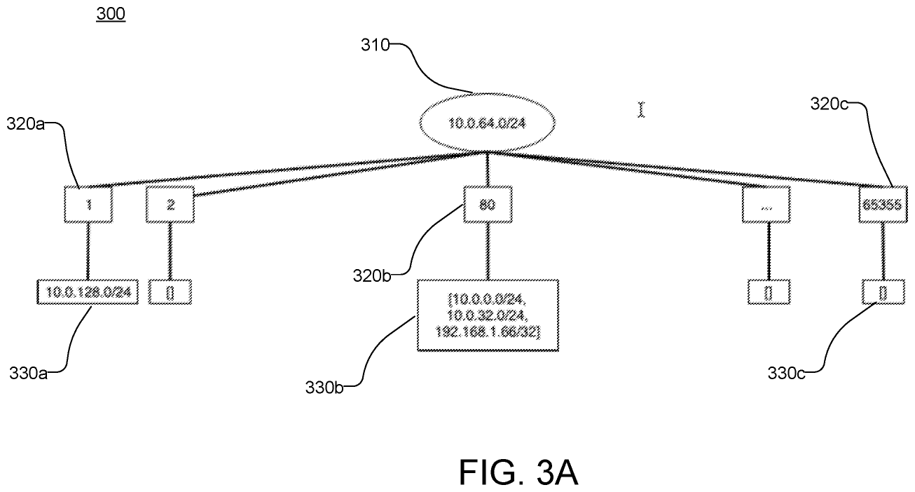

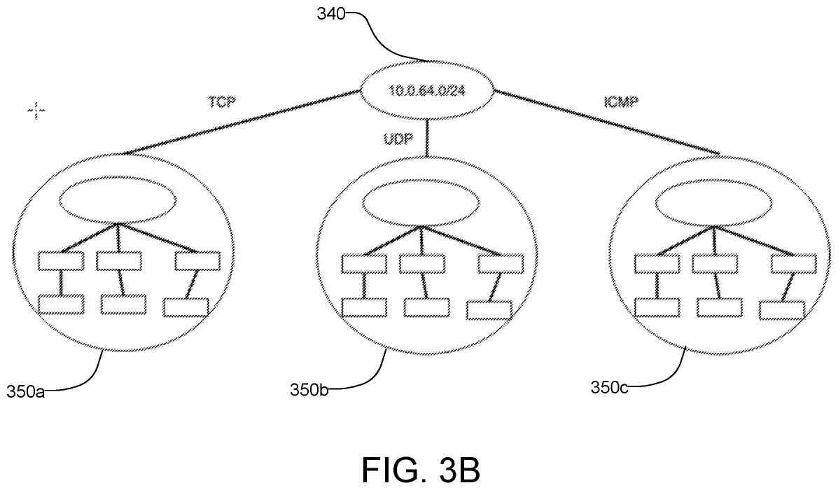

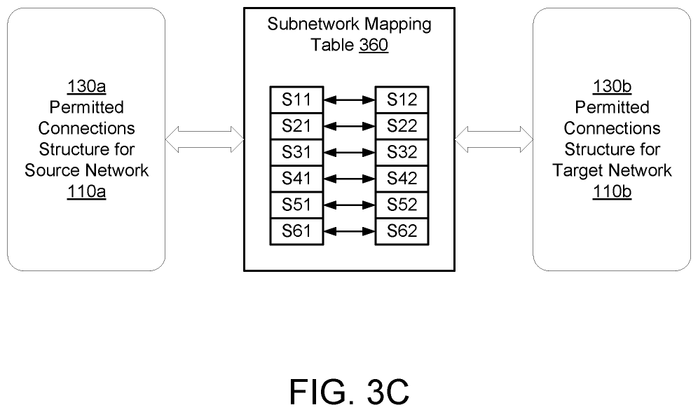

The network security language processor 205 generates a permitted connections structure corresponding to the input network security specification. The permitted connections structure associates each subnetwork of the network with other subnetworks that are permitted to connect with the subnetwork. Examples of permitted connections structure are shown in FIG. 3.

The network security language processor 205 provides information extracted from two network security specifications corresponding to two equivalent networks to the subnetwork mapping module 210. The subnetwork mapping module 210 generates a mapping from subnetworks of one network to corresponding subnetworks of the other network.

In an embodiment, the subnetwork mapping module 210 identifies the same service in both network security specifications. The subnetwork mapping module 210 determines a subnetwork associated with the service from each network security specification and stores an association between the two subnetworks in a subnetwork mapping table. If the subnetwork mapping module 210 determines that the two subnetworks associated with the same service are of different sizes, the subnetwork mapping module 210 identifies a discrepancy indicating the differences in corresponding subnetworks since a network security rules based on the services may have discrepancies.

In an embodiment, the subnetwork mapping module 210 determines a set relationship between two related subnetworks based on their sizes and stores the set relationship in the subnetwork mapping table. For example, if a subnetwork S1 from a network N1 is larger than a corresponding subnetwork S2 of network N2, the subnetwork mapping module 210 stores information indicating S1 as a superset of subnetwork S2. Similarly, if a subnetwork S1 from a network N1 is smaller than a corresponding subnetwork S2 of network N2, the subnetwork mapping module 210 stores information indicating S1 as a subset of subnetwork S2.

The subnetwork mapping module 210 stores the subnetwork mapping table in the subnetwork mapping store. In an embodiment, the network security language processor 205 loads the subnetwork mapping table in memory for fast processing when identifying discrepancies between two network security specifications. In an embodiment, the subnetwork mapping store 215 is a relational database that stores a table with at least two columns, each column storing subnetworks from a network and each row mapping a subnetwork of one of the network to a subnetwork of the other equivalent network. In an embodiment, each column is indexed to allow fast access of the corresponding pair of subnetworks.

The inputs to the network security comparison module 140 include a source network security specification for a source network and a target network security specification for a target network that is equivalent to the source network. For example, the source network may be based on data centers and the target network may be based on a cloud based system. The comparison module 220 compares permitted connections structures for the source and target network security specifications to identify discrepancies between the two network security specifications.

The discrepancy handling module 230 performs actions in response to receiving information describing discrepancies between two network security specifications. In an embodiment, the discrepancy handling module 230 generates a network security report describing the discrepancies. The discrepancy handling module 230 may store the network security report in the network security report store 250. The discrepancy handling module 230 may send an alert to a user, for example, a system administrator describing the discrepancies between two network security specifications.

In an embodiment, discrepancy handling module 230 generates one or more network security rules for adding to the target network security specification to eliminate certain discrepancies compared to the source network security specification. In some embodiments, the discrepancy handling module 230 automatically enforces one or more generated network security rules when the target network security specification is being implemented on the target network. For example, a generated network security rule may block certain communications if certain discrepancies are identified between the source network security specification and the target network security specification.

The network security report store 250 stores reports generated by the network security comparison module 140. The reports describe discrepancies between network security specifications. A report may identify pairs of services that are permitted to connect in one network security specification but are not permitted to connect in another network security specification.

The network security comparison module 140 efficiently identifies discrepancies between network security specifications using the permitted connections structure as described below.

### Permitted Connections Structure

FIG. 3A illustrates a permitted connections structure according to an embodiment. The network security language processor 205 processes the network security specification and builds the permitted connections structure as it encounters information describing permitted connections between subnetworks. If the network security language processor 205 encounters a permitted connection between two services, the network security language processor 205 identifies the subnetworks corresponding to each service of the pair and adds the information to the permitted connections structure.

For each subnetwork 310 corresponding to a service with which other subnetworks can connect, the permitted connections structure comprises a tree structure 300 with subnetwork 310 at the root as illustrated in FIG. 3A. Accordingly, the permitted connections structure is a forest comprising multiple trees, each tree representing permitted connections for a subnetwork.

The tree structure 300 associates a root subnetwork 310 with leaf subnetworks 330 via ports 320. Accordingly, each leaf node represents a subnetwork 330 that is permitted to connect with the subnetwork 310 corresponding to the root node via the corresponding port 320 connecting the leaf node with the root node. If a leaf node corresponding to a port is empty, the network security specification does not allow any traffic on that port. A leaf subnetwork could represent one or more IP ranges, for example, leaf subnetwork 330b or it could represent an empty set, for example, leaf subnetwork 330c.

In an embodiment, the computing system 120 stores a permitted connections structure for each type of networking protocol, for example, TCP, UDP, ICMP, and so on. FIG. 3B illustrates a permitted connections structure according to another embodiment. Accordingly, the root subnetwork 340 is associated with multiple permitted connections structures 350, one for each networking protocol, for example, permitted connections structures 350a for TCP networking protocol, permitted connections structures 350b for UDP networking protocol, and permitted connections structures 350c for ICMP networking protocol.

In another embodiment, the networking protocol is associated with a port node. For example, there may be multiple port nodes for port 80, one for each networking protocol. Other embodiments may use other types of data structures for representing the relations between subnetworks instead of the tree structures illustrated in FIG. 3. For example, the relations between subnetworks may be represented using a table structure, for example, as a database table that comprises three columns: one for a root subnetwork, one for a port, and one for a leaf subnetwork.

In an embodiment, the network security comparison module 140 represents the tree structure illustrated in FIG. 3A using a language, for example, as follows.
root: 10.0.64.0/24
   protocol: “tcp”
   all_ports: [10.0.96.0/24]
   branches:
      1: [10.0.128.0/24]
      2: [ ]
      80: [10.0.0.0/24, 10.0.32.0/24, 192.168.1.66/32]
      . . .
      65355: [ ]

The tree structure may be represented using any language that allows representation of nested objects, for example, extensible markup language (XML), or JAVASCRIPT OBJECT NOTATION (JSON).

FIG. 3C illustrates a subnetwork mapping table that relates the subnetworks of two permitted connections structures according to an embodiment. As shown in FIG. 3C, the subnetwork mapping table 360 relates subnetworks of two equivalent networks, for example, a source network 110a and a target network 110b. Accordingly, subnetwork S11 of the source network corresponds to subnetwork S12 of the target network, subnetwork S21 of the source network corresponds to subnetwork S22 of the target network, subnetwork S31 of the source network corresponds to subnetwork S32 of the target network, and so on. The permitted connections structure 130a for source network 110a is compared with the permitted connections structure 130b for source network 110b using the subnetwork mapping table 360.

### Overall Process

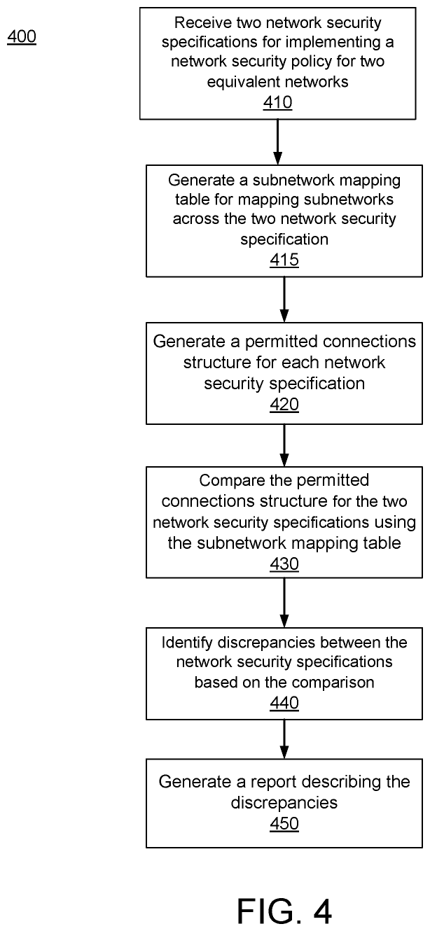

FIG. 4 is a flow chart illustrating the process for identifying discrepancies between network security specifications for two equivalent networks according to one embodiment. Other embodiments can perform the steps of FIG. 4 in different orders. Moreover, other embodiments can include different and/or additional steps than the ones described herein. Although the process illustrated in FIG. 4 illustrates comparison of two network security specifications, the techniques disclosed are applicable to any number of network security specifications that may be two or more. For example, for any set of network security specifications that has more than two network security specifications, the process can be repeated over every possible pair of two network security specifications.

The network security comparison module 140 receives 410 two network security specifications, each network security specification for a network. For example, one network security specification is for a source network and the other network security specification is for a target network. The source and target networks are equivalent. For example, the two networks have matching services that are associated with corresponding subnetworks.

The two network security specifications may be specified using two different network security languages. Each network security specification identifies services available in the corresponding network and defines permitted connections between the services. Each service is associated with a subnetwork of the network. Both network security specifications are expected to implement the same network security policy for the two networks.

The network security language processor 205 compares the two network security specifications to identify the subnetworks associated with the same service specified in the two network security specifications. The network security language processor 205 generates 415 a subnetwork mapping table for mapping subnetworks across the two network security specifications. For example, the subnetwork mapping table stores an association between a subnetwork S1 of the source network and a subnetwork S2 of the target network if the subnetworks S1 and S2 are associated with the same service in the two network security specifications.

The network security language processor 205 parses the network security specification and generates 420 a representation that identifies subnetworks that are permitted to connect with a given subnetwork according to a network security specification, for example, the permitted connections structure 300. The network security language processor 205 generates permitted connections structures P1 and P2 corresponding to the network security specifications.

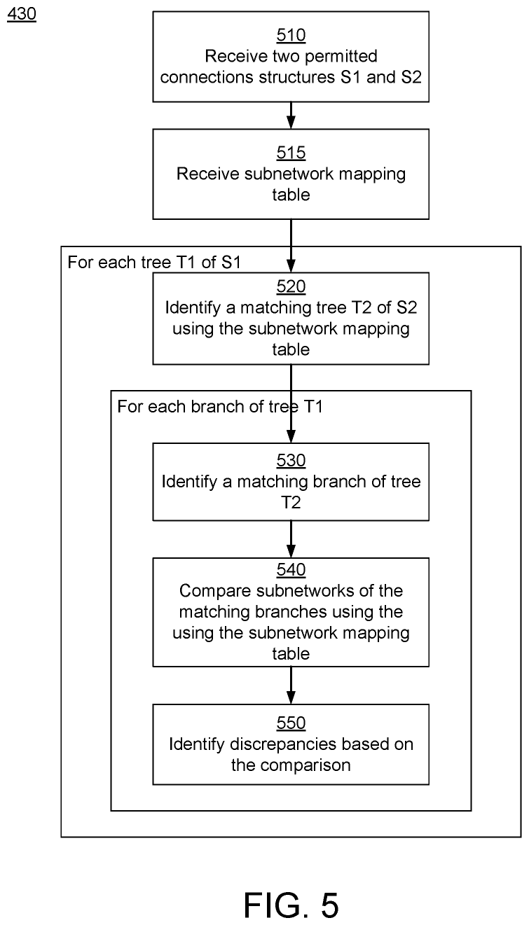

The comparison module 220 compares 430 the permitted connections structures 300 for the two network security specifications. The comparison module 220 may compare 430 the permitted connections structures 300 by matching corresponding pairs of subnetworks that are permitted to connect. Since the two networks use distinct IP addresses, the comparison module 220 uses the subnetwork mapping table to identify corresponding pairs of subnetworks. The details of the comparison are described in connection with FIG. 5.

The comparison module 220 may identify 440 discrepancies based on the matching. Each discrepancy indicates a pair of subnetworks that is permitted to connect in one representation and not permitted to connect in the other representation. For example, assume that the two permitted connections structures are P1 and P2 for networks N1 and N2 respectively. Also assume that the system determines that subnetwork S11 is permitted to connect with subnetwork S12 in permitted connection structure P1. The system identifies the corresponding subnetworks in the other network using the subnetwork mapping table. For example, assume that the subnetwork S11 of network N1 corresponds to subnetwork S21 of network N2 and subnetwork S12 of network N1 corresponds to subnetwork S22 of network N2. The system determines whether S12 is permitted to connect with subnetwork S22 according to the permitted connections structure P2. If S12 is not permitted to connect with subnetwork S22 according to the permitted connections structure P2, the system indicates a discrepancy in the network security specifications.

The discrepancy handling module 230 generates 450 a report describing the discrepancies. The network security comparison module 140 may send the report to a user in a message or may present the report via a user interface.

FIG. 5 is a flow chart illustrating the process for comparing permitted connections structures according to one embodiment. Other embodiments can perform the steps of FIG. 5 in different orders. Moreover, other embodiments can include different and/or additional steps than the ones described herein.

The comparison module 220 receives 510 two permitted connections structures P1 and P2 and performs their comparison. For each tree T1 of the structure P1, the comparison module 220 identifies 520 a corresponding tree T2 of structure P2 such that the two trees T1 and T2 have matching subnetworks at the root node. Two subnetworks are matching if they are related in the subnetwork matching table.

To identify corresponding trees in two permitted connections structures P1 and P2, the comparison module 220 compares the subnetworks of the root nodes of the trees from the two structures. Tree T1 matches tree T2 if the subnetworks of their root nodes are related according to the subnetwork mapping table. The tree T1 may also match tree T2 if the subnetwork of the root node of T2 is indicated as a superset of the subnetwork of the root of T1 in the subnetwork mapping table.

If there is no tree T2 corresponding to tree T1 such their corresponding root nodes have subnetworks that have exact match or subset relationship, the comparison module 220 identifies a tree T2 such that the root nodes of T1 and T2 have overlapping subnetworks. The system identifies any permitted connections of the non-overlapping parts of the two subnetworks as discrepancies. If the comparison module 220 cannot identify any tree T2 corresponding to tree T1 such that the subnetworks of their root nodes have overlapping subnetworks, the comparison module identifies permitted connections associated with trees T1 and T2 as discrepancies.

Once the comparison module 220 identifies corresponding trees T1 and T2, the comparison module 220 iterates through the branches of the tree T1. For each branch of the tree T1 having a leaf node L1, the comparison module 220 identifies the corresponding branch of tree T2 with leaf node L2. The corresponding branches have matching port numbers, i.e., the leaf nodes L1 and L2 are linked to their corresponding root nodes via the same port.

The comparison module 220 compares 540 the corresponding branches. If for a pair of matching branches, the subnetwork S1 of leaf node L1 does not match the corresponding subnetwork NS22 of leaf node L2, the system identifies 550 a discrepancy describing the differences in the subnetworks S1 and S2.

The comparison module 220 considers containment of subnetworks when comparing leaf nodes of trees T1 and T2. Accordingly, if permitted connections structure P1 is being compared against permitted connections structure P2, the comparison module 220 determines whether all IP ranges of a leaf node of tree T1 are same or subsets of the IP ranges of the corresponding leaf node of tree T2 with matching port number. If an IP range of a leaf node of tree T1 is neither same nor a subset of an IP range of the corresponding leaf node of tree T2, the comparison module 220 reports the IP range as a discrepancy. The comparison of permitted connections structure P1 against permitted connections structure P2 may return different discrepancies compared to the comparison of permitted connections structure P2 against permitted connections structure P1.

In an embodiment, the comparison module 220 first compares the permitted connections structure P1 against the permitted connections structure P2 to identify the discrepancies and then compares the permitted connections structure P2 against the permitted connections structure P1 to identify any additional discrepancies. For example, if each branch of the permitted connections structure corresponds to a port, the process of comparison of connections structure P1 against the permitted connections structure P2 may only iterate over all ports in structure P1 that have a permitted connection but may not identify ports that have permitted connections in structure P2 but not in P1. To identify permitted connections that may be present at a port in in structure P2 but not in structure P1, the comparison module 220 compares the structure P2 against the structure P1 and iterates over all ports that have a permitted connection in P2.

### Optimizations

There may be as many leaf nodes as the number of allowed ports, for example 65,535. In some embodiments, the tree structure 300 includes a special port node that represents “all ports” for associating leaf subnetworks 330 that can connect to the root subnetwork 310 via any possible port. This allows such subnetworks to be represented efficiently by connecting them to one port rather than repeating the subnetwork for every port. If the permitted connections structures store a separate branch for representing “all ports”, the system also compares the subnetworks of the leaf nodes of that branch to identify any discrepancies.

In an embodiment, the network security language processor 205 merges subnetworks in the leaf nodes to generate an efficient representation. The leaf node may store a set of IP ranges. The network security language processor 205 receives an IP range for adding to a leaf node and determines whether the IP range already exists in the leaf node or if the IP range is a sub-range of an existing IP range of the leaf node. If the IP range already exists in the leaf node or is a subset of an existing IP range of the leaf node, the network security language processor 205 skips the received IP range. The network security language processor 205 determines whether the IP range is a superset of an existing IP range of the leaf node. If the IP range is a superset of an existing IP range of the leaf node, the network security language processor 205 replaces the existing IP range with the received IP range. This process is repeated for all IP ranges that need to be added to a leaf node.

In an embodiment, after the permitted connections structure is built, the network security language processor 205 analyzes the branches of each tree to identify leaf nodes with matching IP ranges. If network security language processor 205 identifies a leaf node with two identical IP ranges, the network security language processor 205 eliminates one of the IP ranges. If the network security language processor 205 identifies two IP ranges R1 and R2 such that R1 is a subset of R2, the network security language processor 205 eliminates the subset IP range R1 and keeps R2.

### Computer Architecture

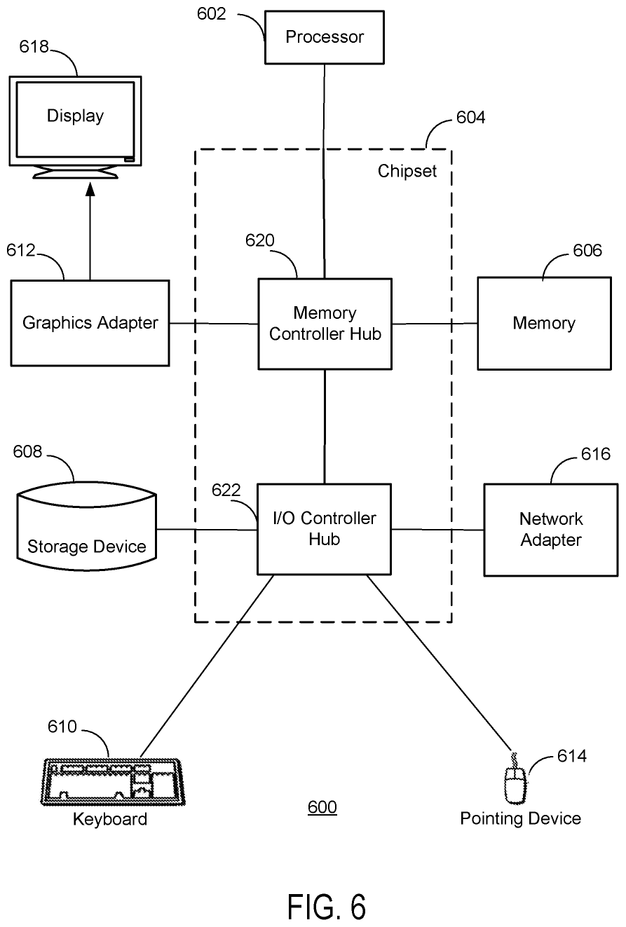

FIG. 6 is a high-level block diagram illustrating a functional view of a typical computer system for use as one of the entities illustrated in the environment 100 of FIG. 1 according to an embodiment. Illustrated are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is a non-transitory computer-readable storage medium, such as a hard drive, compact disk read-only memory (CD-ROM), DVD, or a solid-state memory device. The memory 606 holds instructions and data used by the processor 602. The pointing device 614 may be a mouse, track ball, or other type of pointing device, and is used in combination with the keyboard 610 to input data into the computer system 200. The graphics adapter 612 displays images and other information on the display 618. The network adapter 616 couples the computer system 600 to the network 106.

As is known in the art, a computer 600 can have different and/or other components than those shown in FIG. 6. In addition, the computer 600 can lack certain illustrated components. For example, a computer system 600 acting as an online system 102 may lack a keyboard 610 and a pointing device 614. Moreover, the storage device 608 can be local and/or remote from the computer 600 (such as embodied within a storage area network (SAN)).

The computer 600 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 608, loaded into the memory 606, and executed by the processor 602.

The types of computer systems 600 used by the entities of FIG. 1 can vary depending upon the embodiment and the processing power used by the entity. For example, a client device 104 may be a mobile phone with limited processing power, a small display 618, and may lack a pointing device 614. The online system 102, in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

We claim:

1. A computer-implemented method for comparing network security specifications for equivalent networks, the method comprising:
receiving network security specifications for two different networks that are equivalent to each other, each network having one or more services, each service associated with a subnetwork, each network security specification defining permitted connections between services of the corresponding network;
determining a mapping between corresponding pairs of subnetworks of the two networks based on a mapping of corresponding services between the two networks;
comparing the two network security specifications, comprising:
for each network security specification, generating a representation that, for each of a plurality of subnetworks, identifies a set of other subnetworks that are permitted to connect with that subnetwork according to the network security specification, wherein the representation captures all of the permitted connections defined in the network security specification;
comparing the representations of the two network security specifications by matching corresponding pairs of subnetworks in the representations that are permitted to connect according to the representations, the corresponding pairs identified based on the mapping; and
identifying one or more discrepancies based on the matching, each discrepancy indicating a pair of subnetworks that is permitted to connect in one representation and not permitted to connect in the other representation; and
generating a report describing the one or more discrepancies.

2. The method of claim 1, wherein one of the networks is implemented in one or more data centers of an enterprise and the other network is implemented using a remote cloud based system

3. The method of claim 1, wherein the two different network security specifications are expressed using different languages.

4. The method of claim 1, wherein the two different network security specifications are expressed using different models for describing groupings of services.

5. The method of claim 1, wherein determining the mapping between corresponding pairs of subnetworks of the two networks comprises, repeatedly performing:
selecting a service in one of the two network security specifications;
identifying the service in the other of the two network security specifications; and
creating an association between subnetworks associated with the service as specified by the two network security specifications.

6. The method of claim 1, wherein each subnetwork is represented as one or more internet protocol (IP) ranges.

7. The method of claim 1, wherein the representation comprises:
for each subnetwork, a tree data structure having a root node representing that subnetwork and a plurality of leaf nodes, each leaf node representing a leaf subnetwork, wherein the leaf subnetwork is permitted to connect to the root subnetwork.

8. The method of claim 7, wherein each leaf node is associated with a port, wherein the leaf subnetwork is permitted to connect to the root subnetwork at the port.

9. The method of claim 1, wherein the representation comprises:
for each subnetwork, a plurality of tree data structures, each tree data structure for a communication protocol, each tree data structure having a root node representing a root subnetwork and a plurality of leaf nodes, each leaf node representing a leaf subnetwork, wherein the leaf subnetwork is permitted to connect to the root subnetwork using the communication protocol corresponding to the tree data structure.

10. The method of claim 1, wherein generating the representation for a network security specification comprises:
identifying a pair of subnetworks in the network security specification, the pair comprising a consumer subnetwork and a provider subnetwork such that the consumer subnetwork is permitted to connect to the provider subnetwork; and
adding the consumer subnetwork to the set of subnetworks that are permitted to connect to the provider subnetwork.

11. The method of claim 10, wherein adding the consumer subnetwork to the set of subnetworks that are permitted to connect to the provider subnetwork is responsive to determining that the set of subnetworks does not already include a subnetwork that is either same as the consumer subnetwork or a superset of the consumer subnetwork.

12. The method of claim 10, wherein adding the consumer subnetwork to the set of subnetworks that are permitted to connect to the provider subnetwork comprises:
responsive to determining that the consumer subnetwork is a superset of an existing subnetwork of the set, replacing the existing subnetwork by the consumer subnetwork.

13. A non-transitory computer readable storage medium storing instructions that when executed by a computer processor cause the computer processor to perform steps for comparing network security specifications for equivalent networks, the steps comprising:
receiving network security specifications for two different networks that are equivalent to each other, each network having one or more services, each service associated with a subnetwork, each network security specification defining permitted connections between services of the corresponding network;
determining a mapping between corresponding pairs of subnetworks of the two networks based on a mapping of corresponding services between the two networks;
comparing the two network security specifications, comprising:
for each network security specification, generating a representation that, for each of a plurality of subnetworks, identifies a set of other subnetworks that are permitted to connect with that subnetwork according to the network security specification, wherein the representation captures all of the permitted connections defined in the network security specification;
comparing the representations of the two network security specifications by matching corresponding pairs of subnetworks in the representations that are permitted to connect according to the representations, the corresponding pairs identified based on the mapping; and
identifying one or more discrepancies based on the matching, each discrepancy indicating a pair of subnetworks that is permitted to connect in one representation and not permitted to connect in the other representation; and
generating a report describing the one or more discrepancies.

14. The non-transitory computer readable storage medium of claim 13, wherein one of the networks is implemented in one or more data centers of an enterprise and the other network is implemented using a remote cloud based system

15. The non-transitory computer readable storage medium of claim 13, wherein instructions for determining the mapping between corresponding pairs of subnetworks of the two networks comprise instructions for repeatedly performing:
selecting a service in one of the two network security specifications;
identifying the service in the other of the two network security specifications; and
creating an association between subnetworks associated with the service as specified by the two network security specifications.

16. The non-transitory computer readable storage medium of claim 13, wherein the representation comprises:
for each subnetwork, a tree data structure having a root node representing that subnetwork and a plurality of leaf nodes, each leaf node representing a leaf subnetwork, wherein the leaf subnetwork is permitted to connect to the root subnetwork.

17. The non-transitory computer readable storage medium of claim 13, wherein the representation comprises:
for each subnetwork, a plurality of tree data structures, each tree data structure for a communication protocol, each tree data structure having a root node representing a root subnetwork and a plurality of leaf nodes, each leaf node representing a leaf subnetwork, wherein the leaf subnetwork is permitted to connect to the root subnetwork using the communication protocol corresponding to the tree data structure.

18. The non-transitory computer readable storage medium of claim 13, wherein instructions for generating the representation for a network security specification comprise instructions for:
identifying a pair of subnetworks in the network security specification, the pair comprising a consumer subnetwork and a provider subnetwork such that the consumer subnetwork is permitted to connect to the provider subnetwork; and
adding the consumer subnetwork to the set of subnetworks that are permitted to connect to the provider subnetwork.

19. A computer system comprising:
a computer processor; and
a non-transitory computer readable storage medium storing instructions that when executed by the computer processor cause the computer processor to perform steps for comparing network security specifications for equivalent networks, the steps comprising:
receiving network security specifications for two different networks that are equivalent to each other, each network having one or more services, each service associated with a subnetwork, each network security specification defining permitted connections between services of the corresponding network;
determining a mapping between corresponding pairs of subnetworks of the two networks based on a mapping of corresponding services between the two networks;
comparing the two network security specifications, comprising:
for each network security specification, generating a representation that, for each of a plurality of subnetworks, identifies a set of other subnetworks that are permitted to connect with that subnetwork according to the network security specification, wherein the representation captures all of the permitted connections defined in the network security specification;
comparing the representations of the two network security specifications by matching corresponding pairs of subnetworks in the representations that are permitted to connect according to the representations, the corresponding pairs identified based on the mapping; and
identifying one or more discrepancies based on the matching, each discrepancy indicating a pair of subnetworks that is permitted to connect in one representation and not permitted to connect in the other representation; and
generating a report describing the one or more discrepancies.

20. The computer system of claim 19, wherein one of the networks is implemented in one or more data centers of an enterprise and the other network is implemented using a remote cloud based system
